(19) United States
(12) Patent Application Publication
(10) Pub. No.: US 2012/0242198 A1
(43) Pub. Date: Sep. 27, 2012

(54) VEHICLE DRIVE DEVICE

(75) Inventors: Satoru KASUYA, Nishio (JP); Masashi KITO, Anjo (JP); Yuichi SEKI, Okazaki (JP); Yusuke TAKAHASHI, Anjo (JP); Shigeru SUGISAKA, Nishio (JP)

(73) Assignee: AISIN AW CO., LTD., Anjo-shi (JP)

(21) Appl. No.: 13/353,750

(22) Filed: Jan. 19, 2012

(30) Foreign Application Priority Data
Mar. 22, 2011 (JP) 2011-062328

(51) Int. Cl. H02K 11/00

(52) U.S. Cl. 310/68 B

(57) ABSTRACT

A vehicle drive device including a rotating electrical machine having a rotor and a stator, as a driving source force of wheels; a rotation sensor that detects a rotational position of the rotor with respect to the stator; a rotor support member that supports the rotor at a position radially inside the stator; an oil pump having a pump rotor disposed on a same axis as the rotating electrical machine and drivingly coupled to the rotor support member, and a pump case accommodating the pump rotor; and a support bearing that is placed between the pump case and the rotor support member in a radial direction, and that rotatably supports the rotor support member with respect to the pump case. The rotation sensor and the support bearing are positioned so as to overlap each other as viewed in the radial direction.

### INCORPORATION BY REFERENCE

The disclosure of Japanese Patent Application No. 2011-062328 filed on Mar. 22, 2011 including the specification, drawings and abstract is incorporated herein by reference in its entirety.

### BACKGROUND OF THE INVENTION

The present invention relates to vehicle drive devices that include, as a driving force source of wheels, a rotating electrical machine having a rotor and a stator.

### Description of the Related Art

For example, a device described in Japanese Patent Application Publication No. JP-A-2006-15997 shown below is already known as such a vehicle drive device. In this section “Description of the Related Art,” JP-A-2006-15997 will be described by showing one or both of the names and reference numerals of members in parentheses “[ ].” As shown in FIG. 2 of JP-A-2006-15997, this vehicle drive device includes: a rotation sensor that detects a rotational position of a rotor [21] with respect to a stator [22] of a rotating electrical machine [an electric motor 20]; a rotor support member [a rotor shaft 32] that supports the rotor; and an oil pump having a pump case and a pump rotor accommodated in the pump case.

In this device, the rotor support member is fixed to the outer peripheral surface of an output member [an input shaft 31] shaft-supported with respect to an input member [a rotating shaft 41], whereby the rotor support member is rotatably supported in a radial direction. In JP-A-2006-15997, the rotor support member extends through the pump case as a non-rotating member, but no special member is placed between the pump case and the rotor support member. Thus, there is room for improvement in support accuracy of the rotor of the rotating electrical machine.

As a solution, a bearing can be placed between the pump case and the rotor support member which rotate relative to each other, at a position (which is referred to as the “opposing position” in the section “Description of the Related Art”) where the pump case and the rotor support member face each other in the radial direction. In the device of JP-A-2006-15997, however, the rotation sensor is placed next to the pump case other in an axial direction. Accordingly, the rotation sensor is placed next to the opposing position in the axial direction. Thus, placing the bearing at the opposing position increases an area that is occupied by the rotation sensor and the pump case and the bearing in the axial direction, resulting in an increase of the overall size of the device.

### SUMMARY OF THE INVENTION

Thus, it is desired to implement a vehicle drive device capable of reducing the overall size of the device while satisfactorily maintaining support accuracy of a rotor of a rotating electrical machine.

A vehicle drive device according to a first aspect of the present invention includes: a rotating electrical machine having a rotor and a stator, as a driving source force of wheels; a rotation sensor that detects a rotational position of the rotor with respect to the stator; a rotor support member that supports the rotor at a position radially inside the stator; an oil pump having a pump rotor disposed on a same axis as the rotating electrical machine and drivingly coupled to the rotor support member, and a pump case accommodating the pump rotor; and a support bearing that is placed between the pump case and the rotor support member in a radial direction, and that rotatably supports the rotor support member with respect to the pump case. In the vehicle drive device, the rotation sensor and the support bearing are positioned so as to overlap each other as viewed in the radial direction.

Note that the “rotating electrical machine” is herein used as a concept including all of a motor (an electric motor), a generator (an electric generator), and a motor-generator that functions both as the motor and the generator as necessary.

Regarding arrangement of two members, the expression “overlap as viewed in a predetermined direction” means that when the predetermined direction is a viewing direction and a viewing point is moved in each direction perpendicular to the viewing direction, the viewing point from which the two members are seen to overlap each other is present at least in a region.

According to the first aspect above, the rotor support member is supported in the radial direction via the support bearing with respect to the pump case of the oil pump disposed on the same axis as the rotating electrical machine. Since the pump case is usually fixed to a case etc. accommodating each configuration of the vehicle drive device, the rotor support member is supported by the pump case as a non-rotating member via the support bearing. Thus, support accuracy of the rotor of the rotating electrical machine can be satisfactorily maintained.

Moreover, in the first aspect above, the support bearing and the rotation sensor that detects the rotational position of the rotor of the rotating electrical machine are positioned so as to overlap each other as viewed in the radial direction. Thus, even if such a support bearing is provided, the region that is occupied by the support bearing and the rotation sensor in the axial direction can be reduced as compared to the case where the support bearing and the rotation sensor are arranged next to each other in the axial direction. Thus, the overall size of the device can be reduced.

Accordingly, a vehicle drive device can be implemented which is capable of reducing the overall size of the device while satisfactorily maintaining the support accuracy of the rotor of the rotating electrical machine,

According to a second aspect of the present invention, the stator may have coil end portions that respectively protrude in an axial direction from ends located on both sides in the axial direction of a stator core, and both the rotation sensor and the support bearing may be positioned so as to overlap the coil end portion located on a side of the pump case, as viewed in the radial direction.

According to the second aspect, the region that is occupied in the axial direction by the coil end portion of the stator in addition to the support bearing and the rotation sensor on the side of the pump case with respect to the rotor support member can be reduced. Thus, the overall size of the device can further be reduced.

According to a third aspect of the present invention, the rotor support member may have a first support member and a second support member, the first support member may be configured to contact the rotor to hold the rotor, the second support member may be configured to contact the support bearing and to support the first support member in the radial direction, and a fastening member that fastens and fixes the first support member to the second support member may be positioned so as to overlap the support bearing as viewed in the radial direction.

According to the third aspect, the rotor can be held and can be appropriately supported in the radial direction by using the first support member and the second support member. At this time, since the first support member is fastened and fixed to the second support member by using the fastening member, thermal distortion can be avoided as compared to the case where, e.g., the first support member is bonded to the second support member by welding etc. Thus, in this regard as well, the support accuracy of the rotor can be satisfactorily maintained.

Moreover, in this configuration, the fastening member is positioned so as to overlap the rotation sensor as viewed in the radial direction. Thus, even the use of such a fastening member hardly increases the region that is occupied by the support bearing, the rotation sensor, and the fastening member in the axial direction. Thus an increase in overall size of the device can be suppressed.

According to a fourth aspect of the present invention, the fastening member may be positioned so as to overlap the rotor as viewed in the axial direction.

The rotor support member that supports the rotor at a position radially inside the stator can have a portion that is located radially inside the inner peripheral surface of the stator while supporting the rotor at least from radially inside. According to the fourth aspect, the first support member can be fastened and fixed to the second support member at a radially outer position corresponding to the rotor position, by using the fastening member that is positioned so at to overlap the rotor as viewed in the axial direction.

According to a fifth aspect of the present invention, the vehicle drive device may further include: a second support bearing that rotatably supports the rotor support member on an opposite side from a side of the pump rotor in the axial direction with respect to the support bearing, in addition to the support bearing. In the vehicle drive device, the stator may also have a pair of coil end portions respectively protruding in the axial direction from ends located on both sides in the axial direction of the stator core, and the support bearing and the second bearing may be placed in a region between ends located on both sides in the axial direction of the pair of coil end portions.

According to the fifth aspect, the rotor support member can be rotatably supported, via the support bearing, on the side of the pump rotor in the axial direction with respect to the support bearing, and the rotor support member can be rotatably supported via the second support bearing on the opposite side from the side of the pump rotor. Thus, the rotor support member is supported via the bearings on both sides in the axial direction with respect to the rotor of the rotating electrical machine, whereby the support accuracy of the rotor can more satisfactorily maintained.

Moreover, in the fifth aspect, the support bearing and the second support bearing are placed in the region between the ends located on both sides in the axial direction of the pair of coil end portions located on both sides in the axial direction of the stator. Thus, all of the support bearing, the second support bearing, and the rotation sensor can be fitted and accommodated in the region that is occupied by the stator in the axial direction. Thus, a compact overall configuration of the device can be implemented.

According to a sixth aspect of the present invention, the vehicle drive device may further include: an input member that is drivingly coupled to an internal combustion engine as the driving force source of the wheels; an output member that is drivingly coupled to the rotating electrical machine and the wheels; and a friction engagement device that selectively drivingly couples the input member to the output member. In the vehicle drive device, the first support member may also have a first radially extending portion extending in the radial direction, and an axially extending portion extending in the axial direction from the first radially extending portion toward the side of the pump case, and holding the rotor on an outer periphery of the axially extending portion, the second support member may have a second radially extending portion extending in the radial direction on the side of the pump case with respect to the first radially extending portion, the friction engagement device may be accommodated in a space defined by the first support member and the second support member, and the second radially extending portion may be detachably coupled to the axially extending portion at an end on the side of the pump case of the axially extending portion by using the fastening member.

Note that as used herein, the expression “drivingly coupled” refers to the state in which two rotating elements are coupled together so as to be able to transmit a driving force therebetween, and is used as a concept including the state in which the two rotating elements are coupled together so as to rotate together, or the state in which the two rotating elements are coupled together so as to be able to transmit a driving force therebetween via one or more transmission members. Such transmission members include various members that transmit rotation at the same speed or at a changed speed, and for example, include a shaft, a gear mechanism, a belt, a chain, etc. Such transmission members may include an engagement device that selectively transmits rotation and a driving force, such as a friction clutch.

According to the sixth aspect, the input member can be selectively drivingly coupled to the rotating electrical machine and the output member by the friction engagement device. Thus, in the case where a vehicle includes both the internal combustion engine and the rotating electrical machine as the driving force source, the friction engagement device can be brought into an engaged state as necessary in order to allow a driving force of the internal combustion engine to be transmitted to the wheels, whereby a relatively large driving force can be ensured. Alternatively, the rotating electrical machine and the wheels can be disconnected from the internal combustion engine as necessary, thereby suppressing reduction in energy efficiency when the vehicle is driven only by the driving force of the rotating electrical machine.

Moreover, in the sixth aspect, the friction engagement device is accommodated in the space defined by the first support member and the second support member, and is positioned so as to overlap the axially extending portion and the rotor as viewed in the radial direction. This reduces the region that is occupied by the friction engagement device and the rotating electrical machine, whereby the overall size of the device can be reduced.

Furthermore, in the sixth aspect, the first support member and the second support member are detachable from each other by using the fastening member. This can facilitate assembly, inspection, etc. of the friction engagement device.

According to a seventh aspect of the present invention, a contact surface between the second radially extending portion and the axially extending portion may be positioned so as to overlap the support bearing as viewed in the radial direction.

The fastening member is placed so as to extend through the contact surface between the second radially extending portion and the axially extending portion to fasten and fix the first support member to the second support member. Thus, positioning the contact surface so that the contact surface overlaps the support bearing as viewed in the radial direction as in this configuration enables the fastening member to be positioned so as to overlap both the rotation sensor and the support bearing as viewed in the radial direction. Thus, the overall size of the device can be reduced.

According to an eighth aspect of the present invention, the pump case may have a cylindrical protruding portion having a cylindrical shape and protruding to a side of the rotor in the axial direction, and the support bearing may be placed in contact with an inner peripheral surface of the cylindrical protruding portion, and a sensor stator of the rotation sensor may be placed in contact with an outer peripheral surface of the cylindrical protruding portion.

According to the eighth aspect, the support bearing and the sensor stator of the rotation sensor are placed so as to contact the inner peripheral surface and the outer peripheral surface of the cylindrical protruding portion of the pump case that protrude to the side of the rotor in the axial direction. Thus, the arrangement in which these components overlap each other as viewed in the radial direction can be reduced in size in the radial direction, and can be implemented in a simple manner.

### BRIEF DESCRIPTION OF THE DRAWINGS

FIG. 1 is a schematic diagram showing a schematic structure of a drive device according to an embodiment of the present invention;

FIG. 2 is a partial cross-sectional view of the drive device; and

FIG. 3 is a partial enlarged view of FIG. 2.

### DETAILED DESCRIPTION OF THE EMBODIMENTS

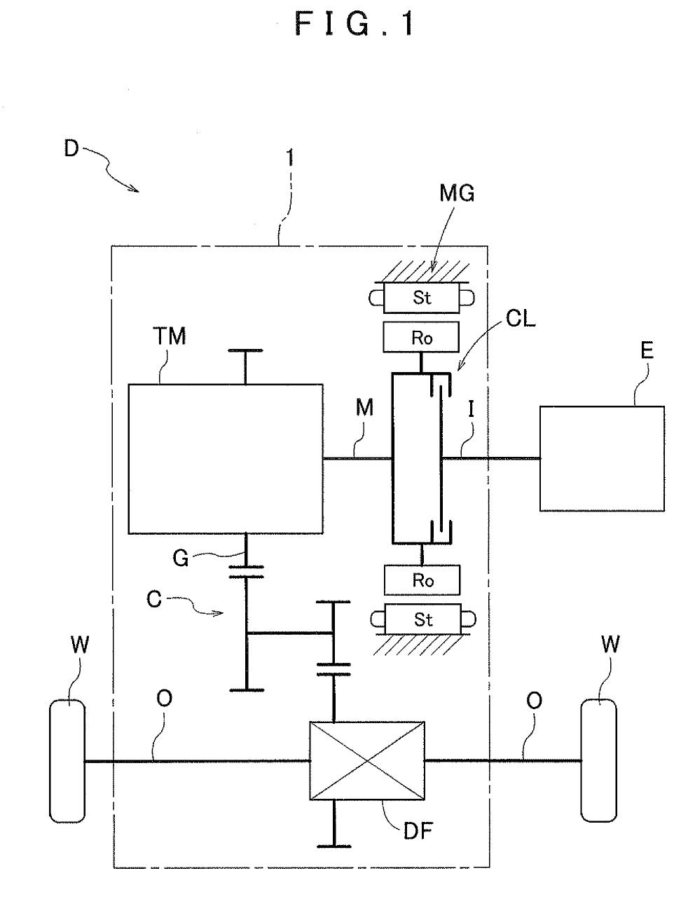

An embodiment of the present invention will be described below with reference to the accompanying drawings. FIG. 1 is a schematic diagram showing a schematic structure of a drive device D according to the embodiment. The drive device D is a drive device for hybrid vehicles (a hybrid drive device) using one or both of an internal combustion engine E and a rotating electrical machine MG as a driving force source of wheels W of a vehicle. The drive device D is configured as a drive device for so-called one-motor parallel type hybrid vehicles. The drive device D of the present embodiment will be described in detail below.

### 1. Overall Configuration of Drive Device

As shown in FIG. 1, the drive device D includes: an input shaft I that is drivingly coupled to the internal combustion engine E; a speed change mechanism TM; an intermediate shaft M that is drivingly coupled to the rotating electrical machine MG and is also drivingly coupled to the speed change mechanism M; and output shafts O that is drivingly coupled to the wheels W. The drive device D further includes: a clutch CL that selectively drivingly couples the input shaft I to the intermediate shaft M; a counter gear mechanism C; and an output differential gear unit DR The rotating electrical machine MG is drivingly coupled to the wheels W via the intermediate shaft M, the speed change mechanism TM, the counter gear mechanism C, the output differential gear unit DF, and the output shafts O. These configurations are accommodated in a case (a drive device case) 1. In the present embodiment, the input shaft I functions as an “input member” in the present invention, and the intermediate shaft M functions as an “output member” in the present invention.

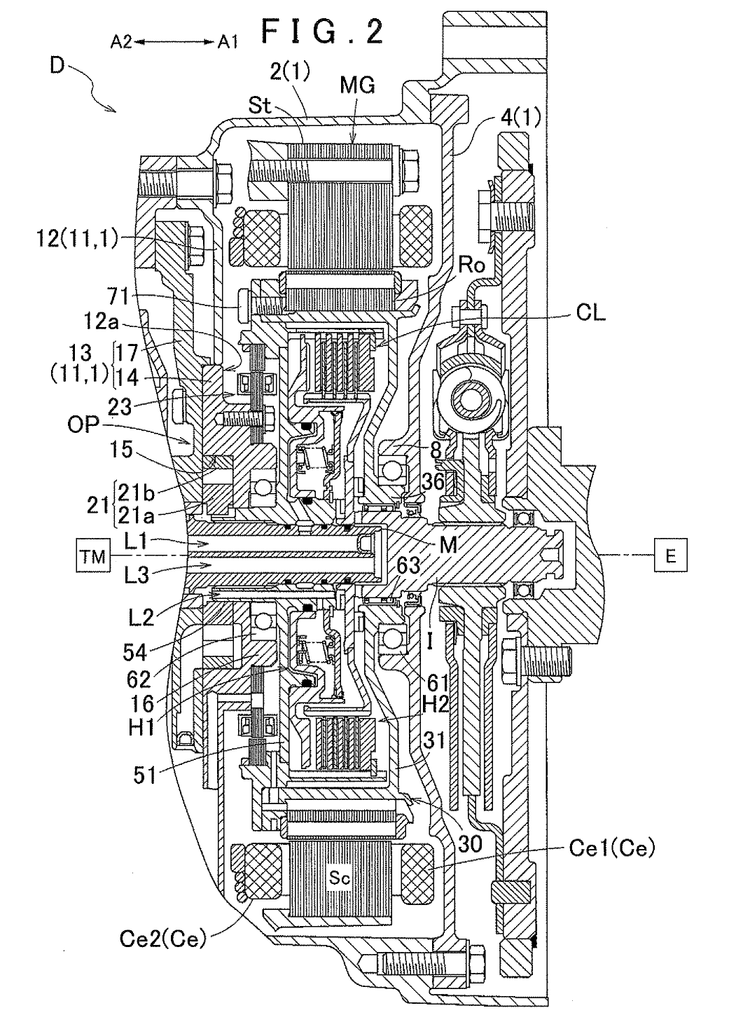

Note that in the present embodiment, the “axial direction,” the “radial direction,” and the “circumferential direction” are defined based on the input shaft I, the intermediate shaft M, and a central axis of rotation of the rotating electrical machine MG which are disposed on the same axis, unless otherwise specified. In the present embodiment, the side of the internal combustion engine E (the right side in FIG. 2) with respect to the rotating electrical machine MG is herein defined as the “axial first direction A1 side,” and the side of an oil pump OP (the left side in FIG. 2), which is the opposite side from the internal combustion engine E with respect to the rotating electrical machine MG is defined as the “axial second direction A2 side.”

The internal combustion engine E is a device that is driven by fuel combustion inside the engine to output motive power. A gasoline engine, a diesel engine, etc. can be used as the internal combustion engine E. An output rotating shaft such as a crankshaft of the internal combustion engine E is drivingly coupled to the input shaft I. The input shaft I is drivingly coupled to the rotating electrical machine MG and the intermediate shaft M via the clutch CL, and the input shaft I is selectively drivingly coupled to the rotating electrical machine MG and the intermediate shaft M by the clutch CL. When the clutch CL is in an engaged state, the internal combustion engine E is drivingly coupled to the rotating electrical machine MG. When the clutch CL is in a disengaged state, the internal combustion engine E is separated from the rotating electrical machine MG.

The rotating electrical machine MG has a stator St and a rotor Ro, and is capable of functioning as a motor (an electric motor) that is supplied with electric power to generate motive power, and as a generator (an electric generator) that is supplied with motive power to generate electric power. Thus, the rotating electrical machine MG is electrically connected to an electricity storage device (not shown). A battery, a capacitor, etc. can be used as the electricity storage device. The rotating electrical machine MG is supplied with electric power from the electricity storage device to perform power running, or supplies electric power, which is generated by torque of the internal combustion engine E or an inertial force of the vehicle, to the battery to store the electric power therein. The rotor Ro of the rotating electrical machine MG is drivingly coupled to the intermediate shaft M so as to rotate together therewith. The intermediate shaft M serves as an input shaft (a shift input shaft) of the speed change mechanism TM.

The speed change mechanism TM is a mechanism that changes the rotational speed of the intermediate shaft M at a predetermined speed ratio to transmit the rotation to a shift output gear G at the changed speed. In the present embodiment, an automatic stepped speed change mechanism, which switchably includes a plurality of shift speeds having different speed ratios, is used as such a speed change mechanism TM. Note that an automatic continuously variable speed change mechanism capable of continuously changing the speed ratio, a manual stepped speed change mechanism switchably including a plurality of shift speeds having different speed ratios, etc. may be used as the speed change mechanism TM. The speed change mechanism TM performs speed change and torque conversion of rotation and torque that are input to the intermediate shaft M, according to a predetermined speed ratio at each point, thereby transmitting the resultant rotation and torque to the shift output gear G.

The shift output gear G is drivingly coupled to the output differential gear unit DF via the counter gear mechanism C. The output differential gear unit DF is drivingly coupled to the wheels W via the output shafts O. The output differential gear unit DF distributes and transmits the rotation and torque, which are input to the output differential gear unit DF, to the two wheels W, namely the right and left wheels W. Thus, the drive device D can transmit the torque of one or both of the internal combustion engine E and the rotating electrical machine MG to the wheels W to cause the vehicle to move.

Note that the drive device D according to the present embodiment has a multi-axis structure in which the input shaft I and the intermediate shaft M are disposed on the same axis, and the output shafts O are disposed on a different axis from that of the input shaft I and the intermediate shaft M so as to extend parallel to each other. Such a structure is suitable for the structure of the drive device D that is mounted on, e.g., front engine front drive (FF) vehicles.

### 2. Configuration of Each Part of Drive Device

The configuration of each part of the drive device D according to the present embodiment will be described below. As shown in FIG. 2, the case 1 includes: a case peripheral wall 2 that surrounds the outer peripheries of the parts accommodated in the case 1 such as the rotating electrical machine MG and the speed change mechanism TM; a first support wall 4 that closes an opening on the axial first direction A1 side of the case peripheral wall 2; and a second support wall 11 that is placed between the rotating electrical machine MG and the speed change mechanism TM in the axial direction on the axial second direction A2 side with respect to the first support wall 4. The case 1 further includes an end support wall (not shown) that closes an end on the axial second direction A2 side of the case peripheral wall 2.

The first support wall 4 extends in the radial and circumferential directions on the axial first direction A1 side of the rotating electrical machine MG and the clutch CL. The first support wall 4 is placed on the axial first direction A1 side with respect to the rotating electrical machine MG and the clutch CL so as to be adjacent to the rotating electrical machine MG and the clutch CL with a predetermined gap therebetween. The first support wall 4 has a through hole in the axial direction, and the input shaft I is inserted through the through hole. Thus, the input shaft I extends through the first support wall 4 and is inserted into the case 1. The first support wall 4 has a cylindrical protruding portion 8 that protrudes toward the axial second direction A2 side in the axial direction. The first support wall 4 rotatably supports a rotor support member 30 on the axial first direction A1 side of the rotating electrical machine MG via the cylindrical protruding portion 8.

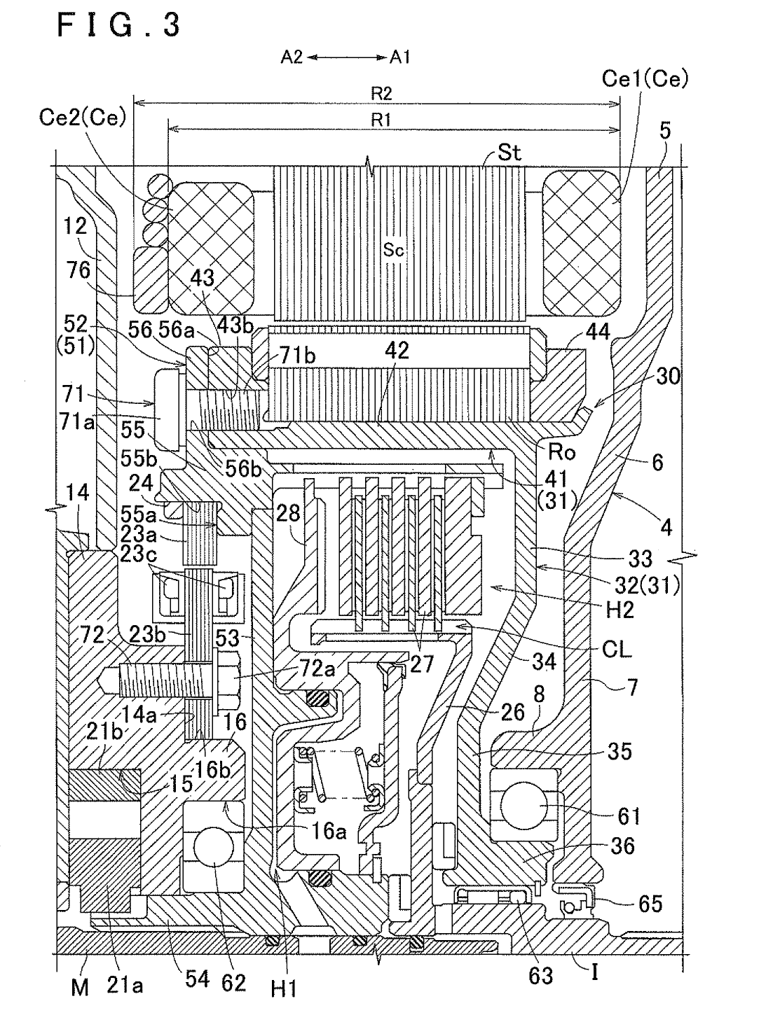

As shown in FIG. 3, the first support wall 4 has an outer wall portion 5, a tilted wall portion 6, and an inner wall portion 7. The outer wall portion 5 is a wall portion forming a radially outer part of the first support wall 4, and extends along the radial direction. A radially outer end of the outer wall portion 5 is fastened and fixed to the ease peripheral wall 2 via a bolt (see FIG. 2). The inner wall portion 7 is a wall portion forming a radially inner part of the first support wall 4, and extends along the radial direction. The inner wall portion 7 is located on the axial second direction A2 side with respect to the outer wall portion 5. The cylindrical protruding portion 8 is formed in the inner wall portion 7. The tilted wall portion 6 obliquely extends so as to connect the outer wall portion 5 with the inner wall portion 7. In this example, the tilted wall portion 6 is tilted so that the tilted wall portion 6 radially extends inward and toward the axial second direction A2 side.

As shown in FIG. 2, the second support wall 11 extends in the radial and circumferential directions on the axial second direction A2 side of the rotating electrical machine MG and the clutch CL. The second support wall 11 is placed on the axial second direction A2 side with respect to the rotating electrical machine MG and the clutch CL so as to be adjacent to the rotating electrical machine MG and the clutch CL with a predetermined gap therebetween. In the present embodiment, the second support wall 11 includes a partition wall 12 formed so as to extend radially inward from the case peripheral wall 2, and a pump case 13 having a pump chamber 15 formed therein to accommodate a pump rotor 21. The pump case 13 is formed by bonding a pump body 14 and a pump cover 17 together. A central opening 12a is formed in a radial central part of the partition wall 12, and the pump body 14 is inserted through the central opening 12a so as to be placed radially inside the partition wall 12. The pump cover 17 is placed so as to contact the pump body 14 from the axial second direction A2.

Each of the pump body 14 and the pump cover 17 of the pump case 13 has a through hole in the axial direction, and the intermediate shaft M is inserted through these through holes. The intermediate shaft M thus extends through the second support wall 11. A cylindrical protruding portion 54 of the rotor support member 30 is inserted between the pump body 14 and the intermediate shaft M which are disposed on the same axis. The pump body 14 has a cylindrical protruding portion 16 protruding in the axial direction toward the first axial direction A1 side. The second support wall 11 rotatably supports the rotor support member 30 on the axial second direction A2 side of the rotating electrical machine MG via the cylindrical protruding portion 16.

The pump rotor 21 is accommodated in the pump chamber 15 formed between the pump body 14 and the pump cover 17. The oil pump OP is formed by the pump rotor 21 and the pump case 13 accommodating the pump rotor 21. In the present embodiment, the pump rotor 21 has a driving gear 21a as an inner rotor and a driven gear 21b as an outer rotor, and the oil pump OP is an internal gear pump. The driving gear 21a of the pump rotor 21 is disposed on the same axis as the rotating electrical machine MG, and is spline coupled to the cylindrical protruding portion 54 of the rotor support member 30 so as to rotate together with the cylindrical protruding portion 54. The oil pump OP sucks oil from an oil pan (not shown) according to rotation of the rotor support member 30, and discharges the sucked oil to supply the oil to the clutch CL, the speed change mechanism TM, the rotating electrical mechanism MG, etc. Note that oil passages are formed inside the pump body 14, the pump cover 17, the intermediate shaft M, etc., and the oil discharged from the oil pump OP is supplied via the oil passages to each part that is to be supplied with the oil.

As shown in FIG. 2, the input shaft I provided so as to extend through the first support wall 4 is drivingly coupled to the internal combustion engine E via a damper on the axial first direction A1 side of the first support wall 4. A hole extending in the axial direction is formed in a radial central part of an end on the axial second direction A2 side of the input shaft 1. The inner peripheral surface of the hole communicates with the outer peripheral surface of the input shaft I via a communication hole extending in the radial direction. The end on the axial second direction A2 side of the input shaft I is coupled to a clutch hub 26 via a flange portion formed so as to extend outward in the radial direction (see FIG. 3).

The intermediate shaft M provided so as to extend through the second support wall 11 is spline coupled to the cylindrical protruding portion 54 of the rotor support member 30. An end on the axial first direction A1 side of the intermediate shaft M is inserted in the axial direction in the hole formed in the input shaft I. The intermediate shaft M has a plurality of oil passages formed therein, including a first oil passage L1 and a third oil passage L3. The first oil passage L1 is formed so as to communicate with a hydraulic oil pressure chamber H1 of the clutch CL. The third oil passage L3 is formed so as to communicate with a circulating oil pressure chamber H2 formed inside the rotor support member 30 via the hole of the input shaft I etc.

The clutch CL is a friction engagement device capable of switching between transmission and interruption of the driving force between the input shaft I and the intermediate shaft M. In, e.g., an electric drive mode (EV mode) in which the vehicle is driven by using only the torque of the rotating electrical machine MG, this clutch CL functions to separate the internal combustion engine E from the rotating electrical machine MG and the output shafts O. That is, the clutch CL functions as a friction engagement device for separating the internal combustion engine. The clutch CL is configured as a wet multi-disc clutch mechanism. As shown in FIG. 3 etc., the clutch CL includes the clutch hub 26, a plurality of friction plates 27, and a piston 28. The clutch hub 26, the friction plates 27, and the piston 28 are accommodated inside the rotor support member 30 formed so as to surround them. Thus, in the present embodiment, the rotor support member 30 functions as a clutch housing that accommodates the clutch CL. Note that the rotor support member 30 is configured to function also as a clutch drum. The plurality of friction plates 27 are provided between the rotor support member 30 spline coupled to the intermediate shaft M and the clutch hub 26 integrally coupled to the input shaft I. The piston 28 as a pressing member is placed on the axial second direction A2 side of the friction plates 27.

In the present embodiment, the hydraulic oil pressure chamber H1 in a fluid-tight state is formed between the rotor support member 30 and the piston 28. Oil discharged from the oil pump OP and adjusted to a predetermined oil pressure by a hydraulic control device is supplied to the hydraulic oil pressure chamber H1 through the first oil passage L1. Engagement and disengagement of the clutch CL are controlled according to the oil pressure that is supplied to the hydraulic oil pressure chamber H1. The circulating oil pressure chamber H2 is formed on the opposite side of the piston 28 from the hydraulic oil pressure chamber H1. The oil discharged from the oil pump OP is supplied to the circulating oil pressure chamber H2 through a second oil passage L2 formed in the cylindrical protruding portion 54 of the rotor support member 30 (see FIG. 2).

As shown in FIG. 2, the rotating electrical machine MG is placed radially outside the clutch CL. The stator St of the rotating electrical machine MG is fixed to the case I. The rotor Ro is rotatably supported radially inside the stator St via the rotor support member 30. The stator St includes a cylindrical stator core Sc that is fixed to the case 1, and a coil that is wound around the stator core Sc. Note that those parts of the coil which protrude in the axial direction from ends located on both sides in the axial direction of the stator core Sc are coil end portions Ce. In this example, the coil end portion on the axial first direction A1 side is referred to as the first coil end portion Ce1, and the coil end portion on the axial second direction A2 side is referred to as the second coil end portion Ce2. Thus, the stator St has the pair of coil end portions Ce1, Ce2 placed on both sides in the axial direction of the stator core Sc.

The rotor support member 30 supports the rotor Ro radially inside the stator St in a state in which the rotor Ro is rotatable with respect to the case 1. With the rotor Ro being fixed to the outer periphery of the rotor support member 30, the rotor support member 30 is supported by the first support wall 4 via a first bearing 61 on the axial first direction A1 side, and is supported by the pump body 14 of the second support wall 11 via a second bearing 62 on the axial second direction A2 side. The rotor support member 30 is formed so as to cover the clutch CL that is placed inside the rotor support member 30. Accordingly, the rotor support member 30 includes a first support member 31 formed so as to cover the axial first direction A1 side of the clutch CL and the radially outer side of the clutch CL, and a second support member 51 formed so as to cover the axial second direction side A2 side of the clutch CL.

The first support member 31 is configured to contact the first bearing 51 and to contact the rotor Ro so as to hold the rotor Ro. The second support member 51 is configured to contact the second bearing 62 and to support the first support member 31 in the radial direction. As shown in FIG. 3, the, first support member 31 has a first radially extending portion 32 extending on the axial first direction A1 side of the clutch CL in the radial direction, and an axially extending portion 41 extending radially outside the clutch CL in the axial direction. The second support member 51 has a second radially extending portion 52 extending on the axial second direction A2 side of the clutch CL in the radial direction.

As shown in FIG. 3, the first radially extending portion 32 extends on the axial first direction A1 side of the clutch CL in the radial and circumferential directions. The first radially extending portion 32 has a through hole in the axial direction, and the input shaft I is inserted through the through hole. Thus, the input shaft I extends through the first radially extending portion 32 and is inserted into the rotor support member 30. The first radially extending portion 32 has a cylindrical protruding portion 36 that protrudes toward the axial first direction A1 side. The cylindrical protruding portion 36 is formed so as to surround the input shaft I. A third bearing 63 is provided between the cylindrical protruding portion 36 and the input shaft I. The first bearing 61 is provided between the cylindrical protruding portion 36 and the cylindrical protruding portion 8 of the first support wall 4. In the present embodiment, the first bearing 61 functions as a “second support bearing” in the present invention.

The first radially extending portion 32 has an outer extending portion 33, a tilted extending portion 34, and an inner extending portion 35. The outer extending portion 33 is an extending portion forming a radially outer part of the first extending portion 32, and extends along the radial direction. The outer extending portion 33 is formed integrally with the axially extending portion 41 at the radially outer end of the outer extending portion 33. The inner extending portion 35 is an extending portion forming a radially inner part of the first radially extending portion 32, and extends along the radial direction. The inner extending portion 35 is located on the axial second direction A2 side with respect to the outer extending portion 33. The cylindrical protruding portion 36 is formed at the radially inner end of the inner extending portion 35. The tilted extending portion 34 obliquely extends so as to connect the outer extending portion 33 with the inner extending portion 35. In this example, the tilted extending portion 34 is tilted so that the tilted extending portion 34 radially extends inward and toward the axial second direction A2 side.

The axially extending portion 41 extends radially outside the clutch CL in the axial and circumferential directions. The axially extending portion 41 is formed in a cylindrical shape, and is formed integrally with the first radially extending portion 32 at the end on the axial first direction A1 side of the axially extending portion 41. That is, the axially extending portion 41 is formed so as to extend in the axial direction from the first radially extending portion 32 toward the axial second direction A2 side. The axially extending portion 41 is fastened and fixed to the second radially extending portion 52 at the end on the axial second direction A2 side of the axially extending portion 41 by first bolts 71. The rotor Ro of the rotating electrical machine MG is fixed and held on the outer periphery of the axially extending portion 41. In the present embodiment, the axially extending portion 41 has a radially supporting portion 42 formed in a cylindrical shape and supporting the rotor Ro from radially inside, and an axially supporting portion 43 formed in an annular shape and supporting the rotor Ro from the axial second direction A2 side. The axially supporting portion 43 extends radially outward from the end on the axial second direction A2 side of the radially supporting portion 42. In this example, the axially supporting portion 43 has a predetermined thickness in the axial direction and in the radial direction. A plurality of fastening holes 43b are formed in the axially supporting portion 43. The plurality of fastening holes 43b are formed so as to be distributed in the circumferential direction. Each fastening hole 43b is formed so as to extend in the axial direction in the axially supporting portion 43. Note that an annular rotor holding member 44 is inserted on the radially supporting portion 42 from the axial first direction A1 side, and the rotor holding member 44 holds the rotor Ro from the axial first direction A1 side.

The second radially extending portion 52 extends on the axial second direction A2 side of the clutch CL in the radial and circumferential directions. The second radially extending portion 52 has a through hole in the axial direction, and the intermediate shaft M is inserted through the through hole. Thus, the intermediate shaft M extends through the second radially extending portion 52, and is inserted into the rotor support member 30. The second radially extending portion 52 has the cylindrical protruding portion 54 that protrudes toward the axial second direction A2 side. The cylindrical protruding portion 54 is formed so as to surround the intermediate shaft M. A part of the inner peripheral surface of the cylindrical protruding portion 54 in the axial direction contacts the outer peripheral surface of the inter mediate shaft M along the entire circumference. The second bearing 62 is provided between the cylindrical protruding portion 54 and the cylindrical protruding portion 16 of the pump body 14. In the present embodiment, the second bearing 62 functions as a “support bearing.”

As shown in FIG. 3, the second radially extending portion 52 has a flat plate-like extending portion 53, a sensor attachment portion 55, and a coupling flange portion 56. The flat plate-like extending portion 53 is an extending portion forming most of the second radially extending portion 52, and extends along the radial direction. The flat plate-like extending portion 53 is formed integrally with the cylindrical protruding portion 54 at the radially inner end of the flat plate-like extending portion 53. The sensor attachment portion 55, which has a cylindrical overall shape and is formed so as to protrude to the axial second direction A2 side with respect to the flat plate-like extending portion 53, is provided radially outside the flat plate-like extending portion 53. The sensor attachment portion 55 has a predetermined thickness in the axial direction and in the radial direction. The sensor attachment portion 55 is positioned so as to overlap the friction plates 27 and a pressing portion of the piston 28 as viewed in the axial direction.

The coupling flange portion 56, which has a shape of an annular disc and is formed so as to extend radially outward from the sensor attachment portion 55, is provided radially outside the sensor attachment portion 55. The coupling flange portion 56 is placed so as to contact the axially supporting portion 43 of the axially extending portion 41 from the axial second direction A2 side. The coupling flange portion 56 and the axially supporting portion 43 are arranged so that their respective radially outer ends are aligned with each other. The same number of insertion holes 56b as the fastening holes 43b are formed in the coupling flange portion 56. Each insertion hole 56b is formed so as to extend through the coupling flange portion 56 in the axial direction at the same radial and circumferential positions as a corresponding one of the fastening holes 43b. The first bolts 71 inserted through the insertion holes 56b from the axial second direction A2 side screw into the fastening holes 43b, respectively, whereby the first support member 31 is fastened and fixed to the second support member 51. In the present embodiment, the first bolts 71 functions as a “fastening member” in the present invention.

Thus, in the present embodiment, the first support member 31 is detachably coupled to the second support member 51 at the end on the axial second direction A2 side of the axially extending portion 41 by using the first bolts 71. The use of such a configuration allows assembly to be performed while checking if each component of the clutch CL accommodated in the circulating oil pressure chamber H2 defined by the first support member 31 and the second support member 51 maintains high accuracy of the central axis. If the accuracy of the central axis does not meet a predetermined standard, the first bolts 71 can be removed to decouple the first support member 31 from the second support member 51 to perform the assembly again. That is, the accuracy of the central axis of the clutch CL can be improved while facilitating the assembly. Similarly, inspection of the clutch CL etc., which is conducted when needed, can also be facilitated.

Moreover, since the first support member 31 is fastened and fixed to the second support member 51 by using the first bolts 71 rather than welding etc., the first support member 31 and the second support member 51 can be coupled together at normal temperature without being heated to a high temperature. This can prevent thermal distortion of the first support member 31 and the second support member 51, whereby satisfactory support accuracy of the rotor Ro can be maintained. Moreover, in the present embodiment, the first bolts 71 fasten and fix the first support member 31 to the second support member 51 at a position where the first support member 31 and the second support member 51 overlap the rotor Ro as viewed in the axial direction, namely at a radial position near the radially outer end of the rotor support member 30.

Note that in this example, the second support member 51 is formed by bonding a first member having the flat plate-like extending portion 53 and a second member having the sensor attachment portion 55 and the coupling flange portion 56 by welding etc. The second support member 51 is formed by cutting a contact portion (including a contact surface) of the second support member 51 with the first support portion 31, the intermediate portion M, etc. after the bonding. Then, the second support member 51 is fastened and fixed to the first support member 31 by using the first bolts 71. Thus, even if thermal distortion is caused by the welding etc. that is conducted in the course of forming the second support member 51, the support accuracy of the rotor Ro is not eventually affected.

As shown in FIGS. 2 and 3, a rotation sensor 23 is provided between the pump body 14 forming the second support wall 11 and the second radially extending portion 52, on the axial second direction A2 side of the rotor support member 30. The rotation sensor 23 is a sensor for detecting the rotational position of the rotor Ro with respect to the stator St of the rotating electrical machine MG. In this example, a resolver is used as such a rotation sensor 23. The rotation sensor 23 has a sensor rotor 23a and a sensor stator 23b. The sensor stator 23b is fixed to the pump body 14 at a position radially outside the cylindrical protruding portion 16. The sensor stator 23b has a protruding coil portion 23c protruding on both sides in the axial direction from a sensor stator core at the radially outer end of the sensor stator 23b. The sensor rotor 23a is placed radially outside the sensor stator 23b, and is fixed to the sensor attachment portion 55 of the second radially extending portion 52 of the rotor support portion 30.

### 3. Arrangement and Configuration of Each Part

The arrangement and configuration of each part of the drive device D will be described below with reference to FIGS. 2 and 3. The arrangement and configuration of the components placed between the first support wall 4 and the second support wall 11 in the axial direction will be described in detail.

The rotor Ro is held in contact with the outer peripheral surface of the radially supporting portion 42 of the axially extending portion 41 forming the rotor support member 30. The clutch CL is accommodated in the circulating oil pressure chamber H2 formed inside the rotor support member 30, and is positioned radially inside the rotor Ro so as to overlap the rotor Ro as viewed in the radial direction. In this example, the entire clutch CL overlaps the rotor Ro (the rotating electrical machine MG). The use of such arrangement and configuration enables the axial length of the space occupied by the clutch CL and the rotor Ro to be reduced by an amount corresponding to the overlapping portion (i.e., the axial width of the clutch CL).

A seal member 65 is placed between the input shaft I and the inner wall portion 7 of the first support wall 4 in the radial direction on the axial first direction A1 side with respect to the clutch CL. The third bearing 63 is placed between the input shaft I and the cylindrical protruding portion 36 of the rotor support member 30 in the radial direction. The third bearing 63 and the seal member 65 are positioned so as to overlap each other as viewed in the axial direction. The third bearing 63 is placed on the axial second direction A2 side with respect to the seal member 65 so as to be adjacent to the seal member 65 with a predetermined gap therebetween. The first bearing 61 is placed in contact with the outer peripheral surface of the cylindrical protruding portion 36. The third bearing 63 and the first bearing 61, which are respectively placed in contact with the inner peripheral surface and the outer peripheral surface of the cylindrical protruding portion 36, are positioned so as to overlap each other as viewed in the radial direction. In this example, a part on the axial first direction A1 side of the third bearing 63 overlaps a part on the axial second direction A2 side of the first bearing 61, as viewed in the radial direction. The outer peripheral surface of the first bearing 61 is in contact with the inner peripheral surface of the cylindrical protruding portion 8. That is, the first bearing 61 is placed between the cylindrical protruding portion 36 and the cylindrical protruding portion 8 in the radial direction. The first bearing 61 is placed between the inner wall portion 7 and the inner extending portion 35 of the first radially extending portion 32 in the axial direction. The first bearing 61 and the cylindrical protruding portion 8 are positioned so as to overlap the inner extending portion 35 as viewed in the axial direction.

The inner extending portion 35 is positioned so as to overlap the third bearing 63 in the radial direction. The outer extending portion 33 of the first radially extending portion 32, which is placed on the axial first direction A1 side with respect to the inner extending portion 35, is positioned so as to overlap both the third bearing 63 and the first bearing 61 as viewed in the radial direction. In this example, the entire outer extending portion 33 overlaps the first bearing 61 as viewed in the radial direction. The outer extending portion 33 is positioned so as to overlap the friction plates 27 and to overlap the tilted wall portion 6 of the first support wall 4, as viewed in the axial direction.

The outer extending portion 33 is positioned so as to overlap the contact surface between the rotor Ro and the rotor holding member 44 as viewed in the radial direction. The rotor Ro and the rotor holding member 44 are positioned so as to overlap the tilted wall portion 6 of the first support wall 4 as viewed in the axial direction. The tilted wall portion 6 is placed on the axial first direction A1 side with respect to the rotor holding member 44 so as to be adjacent to the rotor holding member 44 with a predetermined gap therebetween. The outer extending portion 33 is positioned so as to overlap the first coil end portion Ce1 as viewed in the radial direction. In this example, the outer extending portion 33 overlaps a part of the first coil end portion Ce1 located near the boundary with the stator core Sc, as viewed in the radial direction. The inner wall portion 7 and the tilted wall portion 6 are also positioned so as to overlap the first coil end portion Ce1 as viewed in the radial direction. In this example, the entire inner wall portion 7 overlaps the first coil end portion Ce1 as viewed in the radial direction.

Thus, in the present embodiment, the third bearing 63, the first bearing 61, and the outer extending portion 33 are sequentially arranged in this order along the radial direction on the axial first direction A1 side with respect to the clutch CL. All of the third bearing 63, the first bearing 61, and the outer extending portion 33 are positioned radially inside the first coil end portion Ce1 so as to overlap the first coil end portion Ce1 as viewed in the radial direction. In this example, a part on the axial first direction A1 side of the first bearing 61 overlaps a part on the axial second direction A2 side of the first coil end portion Ce1, as viewed in the radial direction. The seal member 65 and the inner wall portion 7 are positioned radially inside the first coil end portion Ce1 so as to overlap the first coil end portion Ce1 as viewed in the radial direction. The use of such arrangement and configuration reduces the axial length of the space that is occupied by the third bearing 63, the first bearing 61, the seal member 65, the inner wall portion 7, the outer extending portion 33, the first coil end Ce1, etc. on the axial first direction A1 side with respect to the clutch CL.

Note that the first coil end portion Ce1 is positioned so as to overlap the outer wall portion 5 of the first support wall 4 as viewed in the axial direction. The outer wall portion 5 is positioned on the axial first direction A1 side with respect to the first coil end portion Ce1 so as to be adjacent to the first coil end portion Ce1 with a predetermined gap therebetween. Moreover, in the present embodiment, a coil spring forming the damper is positioned radially inside the outer wall portion 5 so as to overlap the outer wall portion 5 as viewed in the radial direction (see FIG. 2). Thus, in the present embodiment, the axial length of the space that is occupied by these components including the damper is reduced.

The second bearing 62 is placed in contact with the outer peripheral surface of the cylindrical protruding portion 54 of the rotor support member 30 on the axial second direction A2 side with respect to the clutch CL. The second bearing 62 is positioned so as to overlap the first bearing 61 and the third bearing 63 as viewed in the axial direction. In this example, an inner race of the second bearing 62 is positioned so as to overlap the third bearing 63 as viewed in the axial direction, and an outer race of the second bearing 62 is positioned so as to overlap an inner race of the first bearing 61 as viewed in the axial direction. The second bearing 62 is positioned so as to overlap the driving gear 21a forming the oil pump OP, as viewed in the axial direction. The second bearing 62 is in contact with an inner peripheral surface 16a of the cylindrical protruding portion 16 of the pump body 14. That is, the second bearing 62 is placed between the cylindrical protruding portion 54 of the rotor support member 30 and the cylindrical protruding portion 16 of the pump body 14 in the radial direction.

The sensor stator 23b of the rotation sensor 23 is placed in contact with an outer peripheral surface 16b of the cylindrical protruding portion 16. The second bearing 62 and the sensor stator 23b, which are respectively placed in contact with the inner peripheral surface and the outer peripheral surface of the cylindrical protruding portion 16, are positioned so as to overlap each other as viewed in the radial direction. In this example, the entire sensor stator core of the sensor stator 23b overlaps the second bearing 62 as viewed in the radial direction. The protruding coil portion 23c on the axial first direction A1 side of the sensor stator 23b overlaps the second bearing 62 as viewed in the radial direction. In the present embodiment, the sensor stator 23b is fastened and fixed to the pump body 15 by a second bolt 72 so as to be in contact with a support contact surface 14a of the pump body 14. At this time, a head 72a of the second bolt 72 is placed between the cylindrical protruding portion 16 and the protruding coil portion 23c in the radial direction. In this example, the head 72a of the second bolt 72 is positioned so as to overlap both the second bearing 62 and the protruding coil portion 23c located on the axial first direction A1 side, as viewed in the radial direction. The cylindrical protruding portion 16, the head 72a of the second bolt 72, and the protruding coil portion 23c located on the axial first direction A1 side are arranged along the radial direction. The flat plate-like extending portion 53 of the second radially extending portion 52 is placed on the axial first direction A1 side of the cylindrical protruding portion 16, the head 72a of the second bolt 72, and the protruding coil portion 23c located on the axial first direction A1 side, so as to be adjacent to them with a predetermined gap therebetween.

The sensor rotor 23a, which is positioned radially outside the sensor stator 23b so as to face the sensor stator 23b, has its outer peripheral surface in contact with an inner peripheral contact surface 55b of the sensor attachment portion 55. The sensor rotor 23a is held by a sensor rotor holding member 24 from the axial second direction A2 side so as to be in contact with a support contact surface 55a of the sensor attachment portion 55 as well. The sensor rotor holding member 24 is positioned so as to overlap the protruding coil portion 23c located on the axial second direction A2 side, as viewed in the radial direction. The coupling flange portion 56 formed radially outside the sensor attachment portion 55 is positioned so as to overlap the sensor rotor 23a (the rotation sensor 23) as viewed in the radial direction. In this example, the entire coupling flange portion 56 overlaps the rotation sensor 23 as viewed in the radial direction. The entire coupling flange portion 56 overlaps the second bearing 62 as well, as viewed in the radial direction. The coupling flange portion 56 is positioned so as to overlap both the axially supporting portion 43 of the axially extending portion 41 and the rotor Ro as viewed in the axial direction. The radially outer ends of the coupling flange portion 56 and the axially supporting portion 43 are located near the radially outer end of the rotor Ro.

Moreover, in the present embodiment, the contact surface 56a between the axially supporting portion 43 of the axially extending portion 41 and the coupling flange portion 56 of the second radially extending portion 52 is positioned so as to overlap both the rotation sensor 23 and the second bearing 62 as viewed in the radial direction. The first bolt 71, which is positioned so as to extend through the contact surface 56a between the coupling flange portion 56 and the axially supporting portion 43 and to fasten and fix the coupling flange portion 56 to the axially supporting portion 43, is also positioned so as to overlap both the rotation sensor 23 and the second bearing 62 as viewed in the radial direction. Particularly in the present embodiment, a head 71a of the first bolt 71 is positioned so as to overlap both the sensor rotor holding member 24 and the protruding coil portion 23c located on the axial second direction A2 side, as viewed in the radial direction, and a shaft 71b is positioned so as to overlap the sensor rotor 23a, the sensor stator core of the sensor stator 23b, the protruding coil portion 23c located on the axial first direction A1 side, and the second bearing 62, as viewed in the radial direction.

The coupling flange portion 56, the axially supporting portion 43, and the first bolt 71 are positioned so as to overlap the second coil end portion Ce2 as viewed in the radial direction. In this example, the coupling flange portion 56, the axially supporting portion 43, and the shaft 71b of the first bolt 71 entirely overlap the second coil end portion Ce2 as viewed in the radial direction.

Thus, in the present embodiment, the second bearing 62, the rotation sensor 23, and the first bolt 71 are sequentially arranged in this order along the radial direction on the axial second direction A2 side with respect to the clutch CL. All of the second bearing 62, the rotation sensor 23, and the first bolt 71 are positioned radially inside the second coil end portion Ce2 so as to overlap the second coil end portion Ce2 as viewed in the radial direction. In this example, the entire second bearing 62 overlaps the second coil end portion Ce2 as viewed in the radial direction. The use of such arrangement and configuration reduces the axial length of the space that is occupied by the second bearing 62, the rotation sensor 23, the first bolt 71, and the second coil end portion Ce2 on the axial second direction A2 side with respect to the clutch CL.

Note that in the present embodiment, a connection terminal 76 is provided which contacts the second coil end portion Ce2 from the axial second direction A2 side to electrically connect a stator coil with a rotating electrical machine control device such as an inverter device (not shown). Both the head 71a of the first bolt 71 and the protruding coil portion 23c located on the axial second direction A2 side are positioned so as to overlap the connection terminal 76 as viewed in the radial direction. The connection terminal 76 is placed radially outside the head 71a of the first bolt 71, and the partition wall 12 extending in the shape of a flat plate along the radial direction is placed on the axial second direction A2 side with respect to the connection terminal 76 and the head 71a of the first bolt 71 so as to be adjacent to them with a predetermined gap therebetween.

As described above, in the drive device D according to the present embodiment, all of the rotor Ro and the rotor support member 30 (except a part on the axial second direction A2 side in the cylindrical protruding portion 54), the clutch CL, the first bearing 61, the second bearing 62, and the third bearing 63 are placed in a stator occupied region R1 that is defined as a region between ends located on both sides in the axial direction of the pair of coil end portions Ce1, Ce2. In addition, all the components including the rotation sensor 23 and the first bolt 71 are placed in an extended stator occupied region R2 that is defined so as to include a region where the connection terminal 76 is placed, in addition to the stator occupied region R1. Thus, in the drive device D according to the present embodiment, all of the clutch CL, the bearings 61, 62, 63, the rotation sensor 23, and the first bolt 71 are accommodated in the region (the extended stator occupied region R2) that is occupied by the stator St in the axial direction. That is, the axial length of the drive device D is effectively reduced, and reduction in overall size of the drive device D is implemented.

### 4. Other Embodiments

Lastly, other embodiments of the vehicle drive device according to the present invention will be described. Note that the configuration disclosed in each of the following embodiments may be applied in combination with the configurations disclosed in the other embodiments as long as no inconsistency arises.

(1) The above embodiment is described with respect to an example in which the first baring 61 and the first coil end portion Ce1 are positioned so that a part of the first bearing 61 overlaps a part of the first coil end portion Ce1 as viewed in the radial direction. The above embodiment is also described with respect to an example in which the second bearing 62 is positioned so that the entire second bearing 62 overlaps the second coil end portion Ce2 as viewed in the radial direction. However, embodiments of the present invention are not limited to this. That is, for example, it is also one of preferred embodiments of the present invention that the first bearing 61 be positioned so that the entire first bearing 61 overlaps the first coil end portion Ce1 as viewed in the radial direction. Alternatively, it is also one of preferred embodiments of the present invention that the first bearing 61 be placed at a different axial position from the first coil end portion Ce1. It is also one of preferred embodiments of the present invention that the second bearing 62 and the second coil end portion Ce2 be positioned so that a part of the second bearing 62 overlaps a part of the second coil end portion Ce2 as viewed in the radial direction. Note that in the case where two members are positioned so that a part of one of the members overlaps a part of the other member as viewed in the radial direction, the two members may be positioned in any relative positional relation in the axial direction.

(2) The above embodiment is described with respect to an example in which the rotation sensor 23 is positioned so as to overlap the second coil end portion Ce2 as viewed in the radial direction. However, embodiments of the present invention are not limited to this. That is, it is also one of preferred embodiments of the present invention that the rotation sensor 23 be positioned at a different axial position from the second coil end portion Ce2.

(3) The above embodiment is described with respect to an example in which the first bolt 71 is positioned so as to overlap the second bearing 62 and the rotation sensor 23 as viewed in the radial direction. However, embodiments of the present invention are not limited to this. That is, it is also one of preferred embodiments of the present invention that the first bolt 71 be placed at a different axial position from the second bearing 62 and the rotation sensor 23. In this case, for example, the second support member 51 can be configured to have the second radially extending portion 52 and the axially extending portion 41 that are integrally formed, the first support member 31 can be configured to have the first radially extending portion 32, and the first bolt 71 can be configured to fasten and fix the axially extending portion 41 to the first radially extending portion 32 at the end on the axial first direction A1 side of the axially extending portion 41. In this case, the first bolt 71 may be positioned so as to overlap one or both of the first bearing 61 and the first coil end portion Ce1 as viewed in the radial direction.

(4) The above embodiment is described with respect to an example in which each of the clutch CL, the bearings 61, 62, 63, the rotation sensor 23, and the first bolt 71 is entirely located in the extended stator occupied region R2. However, embodiments of the present invention are not limited to this. That is, it is also one of preferred embodiments of the present invention that each of the clutch CL, the bearings 61, 62, 63, the rotation sensor 23, and the first bolt 71 be at least partially located in the extended stator occupied region R2.

(5) The above embodiment is described with respect to an example in which the first bolt 71 is positioned so as to overlap the rotor Ro as viewed in the axial direction. However, embodiments of the present invention are not limited to this. That is, it is also one of preferred embodiments of the present invention that the first bolt 71 be placed at a different radial position from the rotor Ro. In this case, for example, a configuration can be used in which the first bolt 71 is positioned so as to overlap the friction plates 27 as viewed in the axial direction.

(6) The above embodiment is described with respect to an example in which the second bearing 62 is placed in contact with the inner peripheral surface 16a of the cylindrical protruding portion 16 of the pump body 14, and the sensor stator 23b is placed in contact with the outer peripheral surface 16b of the cylindrical protruding portion 16 of the pump body 14. However, embodiments of the present invention are not limited to this. That is, it is also one of preferred embodiments of the present invention that one or both of the second bearing 62 and the sensor stator 23b be placed at a position having no relation to the cylindrical protruding portion 16 of the pump body 14. In this case, for example, a configuration can be used in which the sensor stator 23b is placed in contact with the radially outer surface of an axially protruding portion etc. other than the cylindrical protruding portion 16, which is formed radially outside the cylindrical protruding portion 16. Alternatively, a configuration can be used in which, for example, the sensor stator 23b is fixed to the support contact surface 14a of the pump body 14 by the second bolt 72 without being supported in the radial direction by the cylindrical protruding portion 16 etc. Alternatively, a configuration can be used in which the second bearing 62 is placed in contact with the radially inner surface of an axially protruding portion etc. other than the cylindrical protruding portion 16, which is formed radially inside the cylindrical protruding portion 16.

(7) The above embodiment is described with respect to an example in which the sensor stator 23b is fixed to the pump body 14. However, embodiments of the present invention are not limited to this. That is, it is also one of preferred embodiments of the present invention that the sensor stator 23b be fixed to the partition wall 12 or the pump cover 17, depending on the respective sizes and the positional relation of the partition wall 12, the pump body 14, and the pump cover 17.

(8) The above embodiment is described with respect to an example in which the resolver having the sensor rotor 23a and the sensor stator 23b is used as the rotation sensor 23. However, embodiments of the present invention are not limited to this. That is, various configurations such as a Hall integrated circuit (IC), a magnetic resistance element sensor, etc may be used as the rotation sensor 23.

(9) The above embodiment is described with respect to an example in which the first support member 31 and the second support member 51, which form the rotor support member 30, are fastened and fixed together by the first bolt 71. However, embodiments of the present invention are not limited to this. That is, for example, it is also one of preferred embodiments of the present invention that the first support member 31 is bonded to the second support member 51 by welding.

(10) The above embodiment is described with respect to an example in which the drive device D has a multi-axis structure suitable for being mounted on front engine front drive (FF) vehicles. However, embodiments of the present invention are not limited to this. That is, for example, it is also one of preferred embodiments of the present invention that the drive device D has a uniaxial structure in which the output shafts of the speed change mechanism TM are disposed on the same axis as the input shaft I and the intermediate shaft M, and are directly drivingly coupled to the output differential gear unit DF. The drive device D having such a configuration is suitable for being mounted on front engine rear drive (FR) vehicles.

(11) The above embodiment is described with respect to an example in which the vehicle drive device of the present invention is applied to the drive device D for hybrid vehicles including both the internal combustion engine E and the rotating electrical machine MG as the driving force source of the wheels W of the vehicle. However, embodiments of the present invention are not limited to this. That is, the present invention may also be applied to drive devices for electric cars (electric vehicles) including only the rotating electrical machine MG as the driving force source of the wheels W.

(12) Regarding other configurations as well, the embodiment disclosed in the specification is by way of example only in all respects, and embodiments of the present invention are not limited to this. That is, those configurations that are not described in the claims can be modified as appropriate without departing from the scope of the present invention.

The present invention can be preferably used in vehicle drive devices that include, as a driving force source of wheels, a rotating electrical machine having a rotor and a stator.

What is claimed is:

1. A vehicle drive device comprising:
a rotating electrical machine having a rotor and a stator, as a driving source force of wheels;
a rotation sensor that detects a rotational position of the rotor with respect to the stator;
a rotor support member that supports the rotor at a position radially inside the stator;
an oil pump having a pump rotor disposed on a same axis as the rotating electrical machine and drivingly coupled to the rotor support member, and a pump case accommodating the pump rotor; and
a support bearing that is placed between the pump case and the rotor support member in a radial direction, and that rotatably supports the rotor support member with respect to the pump case, wherein
the rotation sensor and the support bearing are positioned so as to overlap each other as viewed in the radial direction.

2. The vehicle drive device according to claim 1, wherein
the stator has coil end portions that respectively protrude in an axial direction from ends located on both sides in the axial direction of a stator core, and
both the rotation sensor and the support bearing are positioned so as to overlap the coil end portion located on a side of the pump case, as viewed in the radial direction.

3. The vehicle drive device according to claim 1, wherein
the rotor support member has a first support member and a second support member,
the first support member is configured to contact the rotor to hold the rotor,
the second support member is configured to contact the support bearing and to support the first support member in the radial direction, and
a fastening member that fastens and fixes the first support member to the second support member is positioned so as to overlap the support bearing as viewed in the radial direction.

4. The vehicle drive device according to claim 3, wherein
the fastening member is positioned so as to overlap the rotor as viewed in the axial direction.

5. The vehicle drive device according to claim 1, further comprising:
a second support bearing that rotatably supports the rotor support member on an opposite side from a side of the pump rotor in the axial direction with respect to the support bearing, in addition to the support bearing, wherein
the stator has a pair of coil end portions respectively protruding in the axial direction from ends located on both sides in the axial direction of the stator core, and
the support bearing and the second bearing are placed in a region between ends located on both sides in the axial direction of the pair of coil end portions.

6. The vehicle drive device according to claim 3, further comprising:
an input member that is drivingly coupled to an internal combustion engine as the driving force source of the wheels;
an output member that is drivingly coupled to the rotating electrical machine and the wheels; and
a friction engagement device that selectively drivingly couples the input member to the output member, wherein
the first support member has a first radially extending portion extending in the radial direction, and an axially extending portion extending in the axial direction from the first radially extending portion toward the side of the pump case, and holding the rotor on an outer periphery of the axially extending portion,
the second support member has a second radially extending portion extending in the radial direction on the side of the pump case with respect to the first radially extending portion,
the friction engagement device is accommodated in a space defined by the first support member and the second support member, and
the second radially extending portion is detachably coupled to the axially extending portion at an end on the side of the pump case of the axially extending portion by using the fastening member.

7. The vehicle drive device according to claim 6, wherein
a contact surface between the second radially extending portion and the axially extending portion is positioned so as to overlap the support bearing as viewed in the radial direction.

8. The vehicle drive device according to claim 1, wherein
the pump case has a cylindrical protruding portion having a cylindrical shape and protruding to a side of the rotor in the axial direction, and
the support bearing is placed in contact with an inner peripheral surface of the cylindrical protruding portion, and a sensor stator of the rotation sensor is placed in contact with an outer peripheral surface of the cylindrical protruding portion.
